(19) United States
(12) Patent Application Publication
(10) Pub. No.: US 2020/0318582 A1
(43) Pub. Date: Oct. 8, 2020

(54) FUEL PREHEATING APPARATUS FOR INTERNAL COMBUSTION ENGINE

(71) Applicant: Elvis E. SELISANA, Caloocan City (PH)

(72) Inventor: Elvis E. SELISANA, Caloocan City (PH)

(21) Appl. No.: 16/625,797

(22) PCT Filed: Jun. 23, 2017
(86) PCT No.: PCT/PH2017/000004

§ 371 Date: Dec. 23, 2019

(51) Int. Cl. F02M 31/14; F28D 15/02

(52) U.S. Cl. CPC F02M 31/145; F28D 2021/0087; F28D 15/0233

(57) ABSTRACT

The present invention provides an apparatus for preheating fuel and cooling liquid in an internal combustion engine system. The fuel preheating apparatus comprising a generally rectangular shape fluid-tight container body with a hollow interior. A top wall of the apparatus being provided with a fuel inlet, a fuel outlet, a coolant inlet, and a coolant outlet. A fuel coiled tubing is provided within the hollow interior and has a first end and a second end where the first end is coupled to the fuel inlet. A coolant coiled tubing is adjacent the fuel coiled tubing and have a first end and a second end where the first end is coupled to the coolant inlet. A degassing tank is coupled to the fuel outlet and the fuel coiled tubing. A buffer tank is coupled to the coolant outlet and the coolant coiled tubing.

### TECHNICAL FIELD

The invention relates to an internal combustion engine and more particularly to a fuel heating apparatus for use in association with internal combustion engines specifically designed for diesel engines or petrol engines.

### BACKGROUND OF THE INVENTION

Efficiency in fuel combustion remains a subject of many research works in order to provide vehicle owners with various advantages such as better fuel economy and to help in the prevention of environmental pollution. In an internal combustion engine where fuel is vaporized and mixed with air for combustion, such efficiency is commonly achieved by preheating the fuel.

It also prevents gelling and solidifying of the fuel. Prior art devices have provided for means to preheat fuel through the use of the heated cooling medium of the engine prior to combustion. For example, see U.S. Pat. No. 1,300,600 to Giesler, and U.S. Pat. No. 3,354,872 to Gratzmuller. A common practice is to maintain a diesel engine running throughout periods of non-use to prevent the difficulty encountered when starting it again. Thus, it is also desirable to maintain the fuel heated when the engine is not running to facilitate starting of the engine and to allow the use of a more economical grade of fuel.

The apparatus of U.S. Pat. No. 3,989,019 is readily installable in engine assemblies and includes a tank or outer housing defining a chamber. The outer housing has inlet and outlet means to allow circulation of the engine cooling medium throughout the chamber. The cooling medium inlet and outlet are connected in the normal circulation system of the engine whereby the heated cooling medium coming from the engine passes through the chamber prior to passage into the radiator for cooling. Fuel inlet and outlet ports are provided in the housing and connected interiorly of the chamber by a fuel passage line disposed in a heat exchanging configuration and preferably constituted as a spiral coil having a series of longitudinally spaced convolutions within the chamber. The heated cooling medium circulates about the coil. As fuel passes through the coil, heat is exchanged from the cooling medium to the fuel in the coil. A removable auxiliary heating element is located in heating relationship to the chamber and is adapted for heating the cooling medium in the chamber as well as the fuel located in the coil when the engine is not running. Preferably the auxiliary heater is constituted as an electric heater which may be plugged in to receive electrical energy from any convenient electrical outlet.

An object of the present invention is to provide an apparatus to preheat fuel prior to combustion in an internal combustion engine. A second object is to provide such an apparatus which employs heat from the engine cooling medium to preheat fuel. A further object of the present invention is to provide such an apparatus having means for expanding thermally the fuel to separate the gas from impurities that may go with fuel. Still a further object of the present invention is provide such an apparatus that may purify and enhance the specific gravity of the remaining fuel in the system to generate complete combustion and to maintain the temperature of the fuel and cooling medium when the engine is not running, thereby allowing an easy start up of the engine. Yet another object of the present invention is to provide such an apparatus that will improve performance efficiency, reduce exhaust smoke emission and reduce fuel consumption.

### SUMMARY OF THE INVENTION

The present invention uses heat from the engine heat exchanger to activate the fuel to be active and smartly vaporizing the fuel as it enters the combustion chamber, consequently, with just a small amount of fuel for sparkling the engine will have an almost total combustion capability.

The present invention provides an apparatus for preheating fuel and cooling liquid in an internal combustion engine system. The fuel preheating apparatus comprising a generally rectangular shape fluid-tight container body being defined by a top wall, a bottom wall, and sidewalls thereof joining said top wall and said bottom wall. The container body has a hollow interior therein; the top wall is provided with a fuel inlet, a fuel outlet, a coolant inlet, and a coolant outlet in fluid communication with the hollow interior. A fuel coiled tubing is provided within the hollow interior and has a first end and a second end where the first end is coupled to the fuel inlet. A coolant coiled tubing is adjacent the fuel coiled tubing and have a first end and a second end where the first end is coupled to the coolant inlet.

A degassing tank has a top end and a bottom end where the top end is coupled to the fuel outlet via the fuel coiled tubing. The bottom end is coupled to the second end of the fuel coiled tubing and a buffer tank has a top end and a bottom end wherein the top end is coupled to the coolant outlet via the coolant coiled tubing and the bottom end is coupled to the second end of the coolant coiled tubing.

Steam is built up around the outer edge of the coolant coiled tubing and the buffer tank as a result of a preheated coolant coming from the internal combustion engine that is entering the coolant coiled tubing through the coolant inlet. The steam build up is capable of preheating the fuel flowing inside the fuel coiled tubing of the fluid-tight container body. Having the preheated fuel thermally expanded inside the degassing tank separates the fuel from impurities thereby purifying and enhancing the specific gravity of the fuel to generate complete combustion.

The arrangement of the apparatus also provides that the preheated coolant passing through the coolant coiled tubing is from a water jacket system of an internal combustion engine, wherein the preheated coolant exiting the coolant coiled tubing towards the engine ensures that the efficiency of the coolant in acting as a coolant agent is achieved.

For better understanding of the invention and to show how the same may be performed, preferred embodiments thereof will now be described, by way of non-limiting examples only, with reference to the accompanying drawings.

### BRIEF DESCRIPTION OF THE DRAWINGS

FIG. 1 is a perspective view of the preferred embodiment of the present invention;

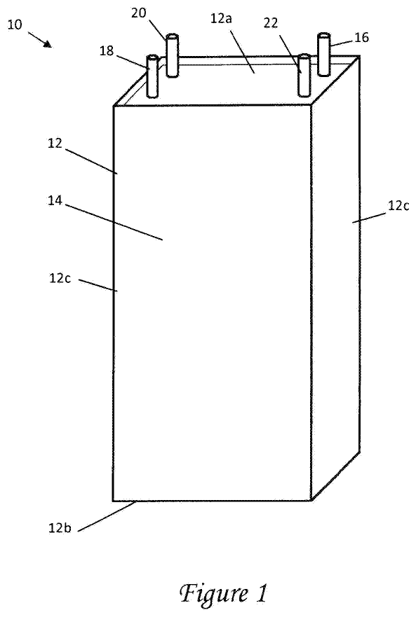

FIG. 2 is a view of exemplary internal components of the present invention of FIG. 1;

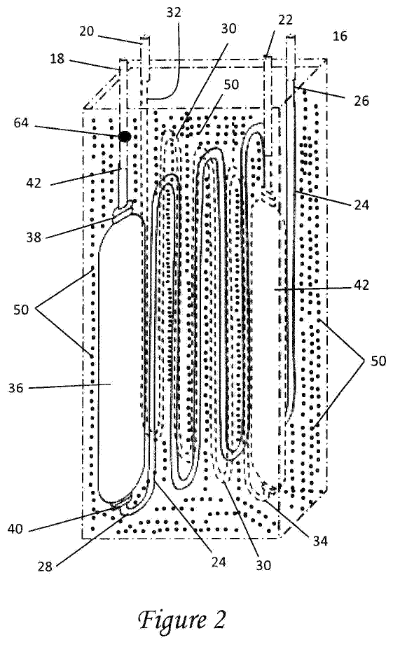

FIG. 3 is a exploded view of the internal components; and

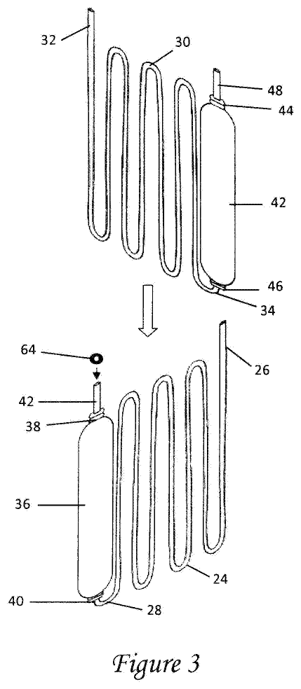

FIG. 4 is a flow diagram of the internal combustion engine system including the apparatus of the present invention.

### DETAILED DESCRIPTION OF THE INVENTION

Referring now to the figures, there is provided a fuel preheating apparatus designated by reference numeral 10 for an internal combustion engine system. The fuel preheating apparatus 10 for an internal combustion engine system comprising a generally rectangular shape fluid-tight container body 12 being defined by a top wall 12a, a bottom wall 12b, and sidewalls 12c thereof joining said top wall 12a and said bottom wall 12b. The container body 12 has a hollow interior 14 therein. The top wall 12a is provided with a fuel inlet 16, a fuel outlet 18, a coolant inlet 20, and a coolant outlet 22 in fluid communication with the hollow interior 14. A fuel coiled tubing 24 is provided within the hollow interior 14 and has a first end 26 and a second end 28 where the first end 26 is coupled to the fuel inlet 16. A coolant coiled tubing 30 is adjacent the fuel coiled tubing 24 and has a first end 32 and a second end 34 where the first end 32 is coupled to the coolant inlet 20.

A degassing tank 36 has a top end 38 and a bottom end 40 where the top end 38 is coupled to the fuel outlet 18 via a fuel tubing. The bottom end 40 is coupled to the second end 28 of the fuel coiled tubing 24 and a buffer tank 42 has a top end 44 and a bottom end 46 wherein the top end 44 is coupled to the coolant outlet 22 via a coolant tubing 48 and the bottom end 46 is coupled to the second end 34 of the coolant coiled tubing 30.

Steam 50 is built up around the outer edge of the coolant coiled tubing 30 and the buffer tank 42 as a result of a preheated coolant coming from the internal combustion engine that is entering the coolant coiled tubing 30 through the coolant inlet 20. The steam 50 build up is capable of preheating a fuel flowing inside the fuel coiled tubing 24 of the fluid-tight container body 12. Having the preheated fuel thermally expanded inside the degassing tank 36 separates the fuel from impurities thereby purifying and enhancing the specific gravity of the fuel to generate complete combustion.

The excess preheated coolant is circulated through the buffer tank 42. This added volume prevents the hot coolant from by-passing the engine cooling jacket system from short cycling. The buffer tank 42 coolant capacity is preferably 25 ml to 50 ml. The buffer tank is preferably made of copper and it can stand pressure of 10 to 100 bar. The buffer tank 42 basically meet up to the heat required to preheat the fuel by emitting steam within the hollow interior of the fluid-tight container body 12. And since steam cannot escape from the hollow interior 14 of the fluid-tight container body 12, the temperature inside increases as well as the pressure. The hollow interior 14 is preferably made polished with epoxy from the inside to withstand the temperature and pressure built within.

The degassing tank 36 removes or dissolves foreign gas from a liquid gas and lowers pressure inside the tank containing solution and to defuse water contamination from fuel resulting to increased and improved specific gravity of fuel. So once the degassing tank 36 heats up, it helps the buffer tank 42 equalize the steaming process inside the hollow interior 14. Therefore, there is consistency and efficiency in the treatment of fuel into gas form and the purification of fuel is made faster.

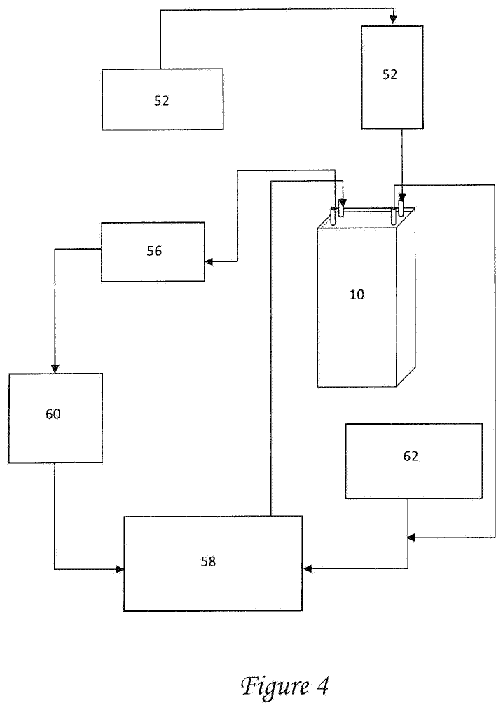

FIG. 4 refers to the flow diagram of the internal combustion engine system including the apparatus of the present invention. Fuel is delivered by a fuel filter 54 from a fuel tank 52 into the fuel inlet 16 of the apparatus 10. Coolant, preferably water, is pumped into the coolant inlet 20 from the internal combustion engine 58. The process of preheating fuel takes place as mentioned above. The preheated fuel exits into the fuel outlet 18 of the apparatus 10 and into the combustion chamber of the engine 58 via a fuel pump 56 and a fuel injector 60. The reduced coolant temperature, from the process of preheating fuel, exits the coolant outlet 22 and into a line connecting a radiator 62 to the engine 58.

Under normal conditions, the average temperature of the fuel in the fuel filter 54 originating from the fuel tank 52 is about 38° C., depending on various external factors to which the fuel tank 52 or the fuel itself is subjected; whereas, the average temperature of water originating from the water jacket system of the engine 58 is in the range of about 50° C. and about 85° C., depending on various factors such as operating time of the engine 58 and the environment to which the engine 58 is exposed. The water from the water jacket system of the engine 58 is therefore preheated at said range of temperature. When the engine 58 starts to operate and fuel is subsequently pumped by the fuel pump 56 in the direction of the engine 58 from the fuel tank 52, the flow of fuel in the fuel inlet 16 of the apparatus 10. If and when the engine 58 reaches a certain temperature, the radiator 62 normally supplies water to the engine 58 so a s to enable the engine to operate at am optimum range of temperature, whereby the engine can continue to perform its function without overheating in an instant, Once the coolant is supplied by the radiator 62 in the direction of the engine 58, the flow of coolant will pass through the coolant inlet 22 of the apparatus 10.

The flow of fuel and the flow of coolant will become simultaneous at some point, after a certain period of operation of the engine 58. When this simultaneous flowing of the fuel and the coolant takes place in their respective coiled tubings 24 and 30 inside the apparatus 10, heat exchange occurs instantaneously between the fuel of lower temperature and the coolant of higher temperature through the hollow interior 14 by means of steam emitting from the coolant coiled tubing 30 and buffer tank 42. A certain amount of heat energy is therefore transferred from the preheated coolant into the fuel. This heat energy preheats the fuel flowing from the fuel inlet 16 through the fuel outlet 18 of the apparatus 10. The preheated fuel, upon exiting through the fuel outlet 18 of the apparatus 10 may reach a temperature close to the temperature of the preheated coolant, a temperature that ranges from about 50° C. to about 85° C. At this range of temperature, it was found out that the transferred heat energy from the coolant to the fuel is sufficient enough to expand the fuel by an amount effective to achieve at least an accelerated fuel combustion in an internal combustion engine. Depending on the type of fuel and on the actual temperature of the fuel by the time it exits through the fuel outlet 18 of the apparatus 10, the fuel may expand by about 5% to about 15% in volume.

The preheated coolant passing through the coolant coiled tubing 30 comes from a water jacket of the internal combustion engine 58 and being directed back to the engine 58 at a reduced temperature.

At least one magnet 64 is provided along the fuel coiled tubing 24 between the top end 38 of the degassing tank 36 and the fuel outlet 18. The preheated fuel passes through this magnet 64 and through the magnetic field created by the magnet 64, the molecular structures of the fuel can be lined up and further help increase combustion.

Each of the temperature of the preheated fuel and the temperature of the preheated coolant is at the range of 50° C. to 85° C.

The container body 12, the fuel coiled tubing 24, the coolant coiled tubing 30, the fuel inlet 16, the fuel outlet 18, the coolant inlet 20, the coolant outlet 22, the degassing tank 36, and the buffer tank 42 are preferably being made of non-corrosive and thermally conductive material. The non-corrosive and thermally conductive material preferably being stainless steel or brass copper.

Below are test results on the performance of an engine with the apparatus installed as compared to the standard engine condition or without the apparatus.

1. As shown below in the graph, the torque produced by the engine equipped with the apparatus of the present invention is higher than the standard engine condition. The significant increment appeared at all engine speed conditions with an average of 7.03%. The maximum increase is 8.57% at 2000 rpm. At maximum engine speeds, the difference are minimal.

2. The graph below illustrates the brake power (BP) against engine speed. The BP is being derived from the torque and engine speed measurements. With the apparatus of the present invention, the BP is increased by 8.33% at engine speed of 200 rpm. The average increase is 6.88%.

3. The graph below [symbol] Standard [symbol] Apparatus [symbol] (BSFC) against engine speed. BSFC indicates the level of fuel used during engine operation. The BSFC decreased by 5.31% on the average at the range of 1500-4000 rpm when installed with the apparatus.

4. This graph below illustrates the brake thermal efficiency against engine speed. It shows the brake thermal efficiency is increased by 7.33% when installed with the apparatus.

1. A fuel preheating apparatus for an internal combustion engine system comprising:
a generally rectangular shape fluid-tight container body being defined by a top wall, a bottom wall, and sidewalls thereof joining said top wall and said bottom wall; said container body having a hollow interior therein; said top wall being provided with a fuel inlet, a fuel outlet, a coolant inlet, and a coolant outlet in fluid communication with said hollow interior;
a fuel coiled tubing being provided within said hollow interior; said fuel coiled tubing having a first end and a second end; said first end being coupled to said fuel inlet;
a coolant coiled tubing adjacent said fuel coiled tubing; said coolant coiled tubing having a first end and a second end; said first end being coupled to said coolant inlet;
a degassing tank having a top end and a bottom end, said top end being coupled to said fuel outlet via said fuel coiled tubing, said bottom end being coupled to said second end of said fuel coiled tubing; and
a buffer tank having a top end and a bottom end, said top end being coupled to said coolant outlet via said coolant coiled tubing, said bottom end being coupled to said second end of said coolant coiled tubing;
wherein
steam being built up around the outer edge of said coolant coiled tubing and said buffer tank as a result of a preheated coolant coming from the internal combustion engine entering said coolant coiled tubing through said coolant inlet; said steam build up being capable of preheating said fuel flowing inside said fuel coiled tubing of said fluid-tight container body; and
wherein
said preheated fuel being thermally expanded inside said degassing tank to separate the fuel from impurities thereby purifying and enhancing the specific gravity of the fuel to generate complete combustion.

2. The fuel preheating apparatus of claim 1, wherein said preheated coolant passing through said coolant coiled tubing comes from a water jacket of said internal combustion engine and being directed back to said engine at a reduced temperature.

3. The fuel preheating apparatus of claim 1, wherein at least one magnet being provided along the fuel coiled tubing between the top end of said degassing tank and said fuel outlet.

4. The fuel preheating apparatus of claim 1, wherein each of the temperature of said preheated fuel and the temperature of said preheated coolant is at the range of 50° C. to 85° C.

5. The fuel preheating apparatus of claim 1, wherein said coolant being preferably water.

6. The fuel preheating apparatus of claim 1, wherein said container body, said fuel coiled tubing, said coolant coiled tubing, said fuel inlet, said fuel outlet, said coolant inlet, said coolant outlet, said degassing tank, and said buffer tank preferably being made of non-corrosive and thermally conductive material.

7. The fuel preheating apparatus of claim 6, wherein said non-corrosive and thermally conductive material preferably being stainless steel.

8. The fuel preheating apparatus of claim 6, wherein said non-corrosive and thermally conductive material preferably being brass copper.
